(19) United States
(12) Patent Application Publication
(10) Pub. No.: US 2015/0205386 A1
(43) Pub. Date: Jul. 23, 2015

(54) PEN GESTURES FOR NAVIGATION

(71) Applicant: Lenovo (Singapore) Pte. Ltd., Singapore (SG)

(72) Inventors: Song Wang, Cary, NC (US); Scott Edwards Kelso, Cary, NC (US); Steven Richard Perrin, Raleigh, NC (US); Bradley Park Strazisar, Cary, NC (US)

(73) Assignee: Lenovo (Singapore) Pte. Ltd., Singapore (SG)

(21) Appl. No.: 14/161,093

(22) Filed: Jan. 22, 2014

(51) Int. Cl. G06F 3/0354

(52) U.S. Cl. CPC G06F 3/03545

(57) ABSTRACT

An aspect provides a method, including: receiving, via a writing input surface of an information handling device, content input from a pen; inputting, using a processor, the content input from the pen; detecting, using a processor, an event triggering entry into a pen navigation mode; entering, using a processor, the pen navigation mode; receiving, via the pen, pen navigation inputs; and controlling, using a processor, navigation based on the pen navigation inputs. Other aspects are described and claimed.

### BACKGROUND

Information handling devices (“devices”) come in a variety of forms, for example desktop or laptop computing devices, tablet computing devices, smart phones, and the like. Device users are increasingly relying on pens to write down important notes that are too long and/or inconvenient to type without the use of physical keyboards.

When using a device under this circumstance a typical user will often hold the device in one hand and write with the other. This mode of input of course leaves no hand free for providing other inputs, e.g., touch or swipe gestures.

### BRIEF SUMMARY

In summary, one aspect provides a method, comprising: receiving, via a writing input surface of an information handling device, content input from a pen; inputting, using a processor, the content input from the pen; detecting, using a processor, an event triggering entry into a pen navigation mode; entering, using a processor, the pen navigation mode; receiving, via the pen, pen navigation inputs; and controlling, using a processor, navigation based on the pen navigation inputs.

Another aspect provides an information handling device, comprising: a writing input surface; a processor operatively coupled to the pen input surface; a memory device that stores instructions accessible to the processor, the instructions being executable by the processor to: receive, via the writing input surface, content input from a pen; input the content input from the pen; detect an event triggering entry into a pen navigation mode; enter the pen navigation mode; receive pen navigation inputs; and control navigation based on the pen navigation inputs.

A further aspect provides a product, comprising: a storage device having code stored therewith, the code being executable by a processor and comprising: code that receives, via a writing input surface of an information handling device, content input from a pen; code that inputs the content input from the pen; code that detects an event triggering entry into a pen navigation mode; code that enters the pen navigation mode; code that receives, via the pen, pen navigation inputs; and code that controls navigation based on the pen navigation inputs.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of using pen gestures for navigation.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When using a device with a pen, e.g., to provide content input to a writing surface such as a touch screen or digitizer, a typical user will often hold the device in one hand and write with the other, leaving no hand for other inputs, e.g., navigation inputs such as touch or swipe gestures. Existing solutions have several shortcomings. Touch based gestures, e.g., provided to the writing surface, require a user to free at least one finger from the pen holding hand or give up the pen entirely in order to provide the touch input. Handling navigation while using a pen in this fashion results in reduced productivity, e.g., time lost or even misplacement of the pen. Some control user interfaces will allow in-application pen input to provide some navigational control, e.g., selection of navigational buttons or scroll bars. However, these approaches are piecemeal at best and are typically located at specific sections of a writing surface. Among other difficulties, this requires the user to locate these controls areas and manually use the same.

Accordingly, an embodiment defines navigation gestures that are entirely pen based and do not interfere with the ways in which a user typically holds and uses a device with pen. In an embodiment, content input is received, e.g., via a writing input surface of a device and input into an application as usual. However, an embodiment may detect an event triggering entry into a pen navigation mode, which allows an embodiment to enter into the pen navigation mode and thereafter receive pen navigation inputs, e.g., via the pen. An embodiment thus allows a user to control navigation, e.g., vertical and lateral scrolling, based on the pen navigation inputs.

The illustrated example embodiments will be best understood by reference to the figures. The following description is intended only by way of example, and simply illustrates certain example embodiments.

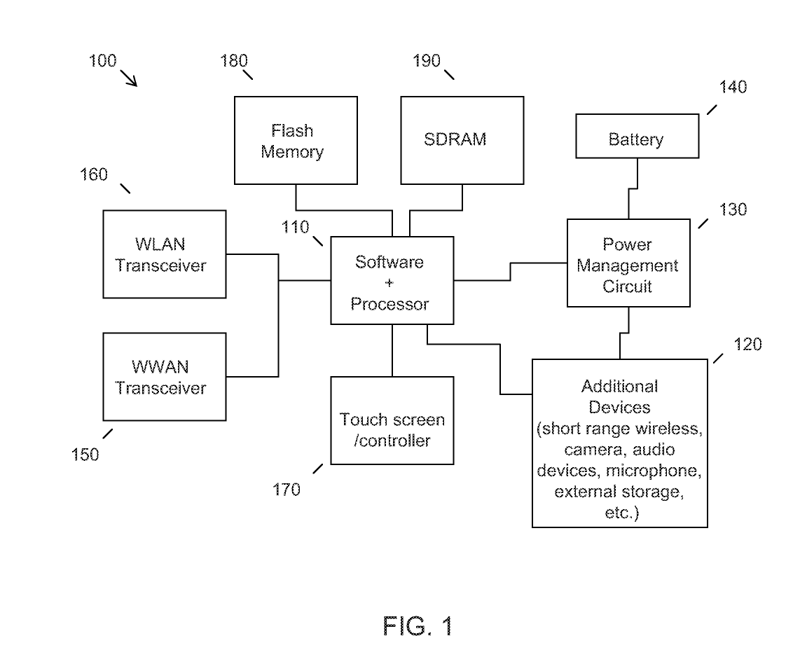

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 such as a camera are commonly included. System 100 often includes a touch screen 170 for data input and display/rendering, e.g., receiving content and navigation inputs via a pen or stylus, as further described herein. System 100 also typically includes various memory devices, for example flash memory 180 and SDRAM 190.

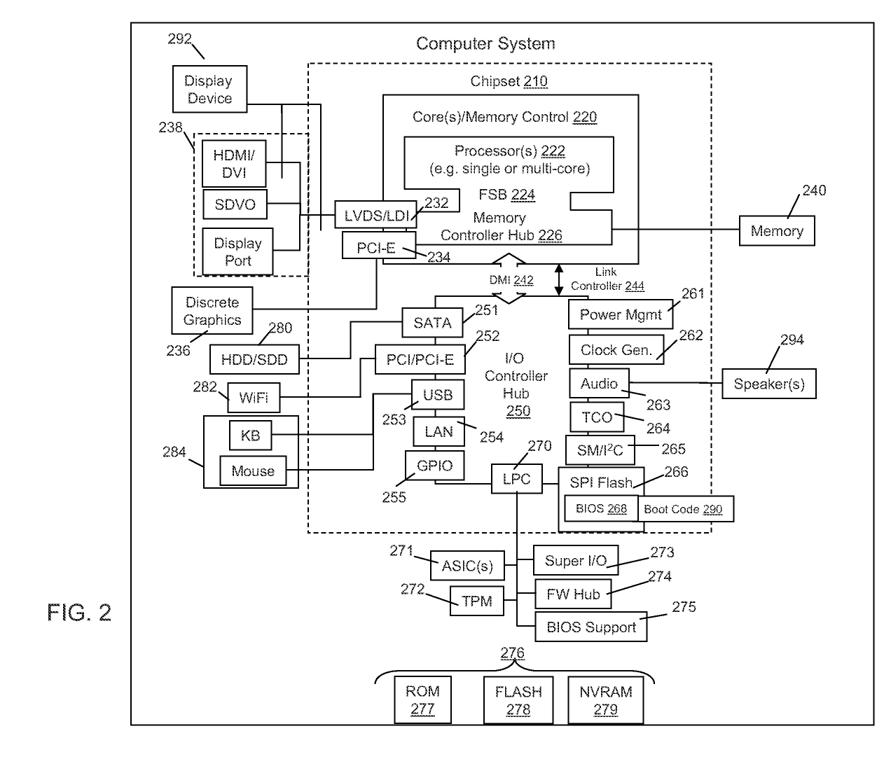

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be included in user devices that accept pen inputs to a writing surface such as a touch screen. An embodiment defines navigation gestures that are entirely pen based and do not interfere with the ways in which a user typically holds and uses a device with pen.

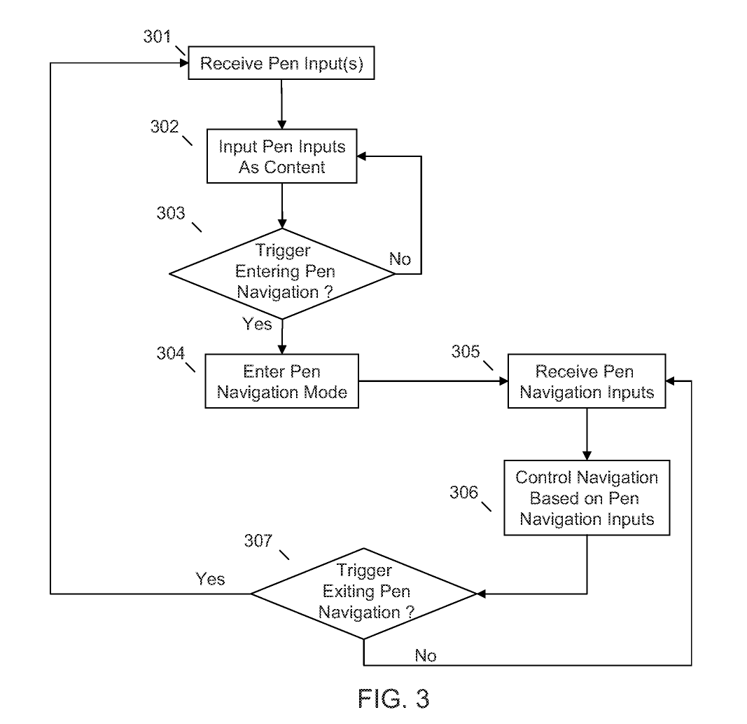

Referring to FIG. 3, for example, in an embodiment, content input is received at 301, e.g., via a writing input surface of a device. This input may be input into an application, e.g., email or word processing application running on the device at 302. An embodiment may detect an event triggering entry into a pen navigation mode at 303, which allows an embodiment to enter into the pen navigation mode at 304 and thereafter receive pen navigation inputs at 305, e.g., via the pen.

The trigger event for entering into the navigation mode may be detected at 303 in a variety of ways. As a non-limiting example, to enter the navigation mode, an embodiment may detect that a user holds the pen still while touching the writing surface, e.g., at a point on the writing input surface. If an embodiment detects that the touch point is maintained, e.g., substantially still within a threshold of x and y coordinates/predetermined area over a predefined period of time, an embodiment may thereafter enter the navigation mode. This threshold may be adjusted and allows for small changes, i.e., a user is not expected to hold the pen absolutely still but only substantially still.

As another example, if the pen is capable of detecting, e.g., pressure and tilt, an embodiment may detect a trigger for entering into navigation mode at 303 via detecting, e.g., that the pen has been placed in a predetermined orientation, e.g., straight down on the writing surface. Thus, if the pen's tilt position is below a threshold degree of change, and/or the system detects pressure maintained within a threshold range, and/or the touch point is also maintained within a threshold x and y coordinate range (as referenced above), an embodiment may use this/these detections as a trigger for entering pen navigation mode at 304.

An embodiment thus allows a user to control navigation via receiving pen navigation inputs at 305 while in pen navigation mode. For example, vertical and/or lateral scrolling type navigation control may be implemented based on the pen navigation inputs received at 305. Some example defined pen navigation inputs that may be received at 305 and used to control navigation at 306 include but are not necessarily limited to the following.

If an embodiment detects a pen input to the writing surface associated with the pen moving upward on the writing surface, an embodiment may control navigation at 306 via scrolling content, e.g., rendered in a display device, upward. Similarly, a detection of a pen moving downward on the writing surface may control navigation to scroll downward. If a detection of a pen moving laterally, e.g., leftward and/or rightward, may control navigation by implementing lateral scrolling. It should be understood that other navigational controls, e.g., at degrees in between lateral and vertical scrolling, as well as other navigational controls, may be implemented on the basis of received pen navigational inputs, e.g., provided to the writing surface at 305.

To get out of the navigation mode, an embodiment may use detection of a variety of triggers at 307, e.g., similar to detecting a trigger entering the navigation mode at 303. For example, an embodiment may detect that the user has repeated the same action with the pen used to enter the pen navigation mode.

The particular gestures described heretofore are targeted toward passive pen/stylus content and navigation controls, e.g., pens that have no pressure and tilt detection. However, for pens that have active detection, e.g., of pressure and/or tilt, the gestures for pen may be expanded or modified. Some non-limiting examples are as follows.

An embodiment may detect that a user has tilted such an active pen backwards, e.g., similar to tilting the pen as a joystick on the writing surface. Responsive to receiving such a pen navigation input at 305, an embodiment may map the received pen navigation input to a predetermined navigation action, e.g., downward scrolling. Similarly, if an embodiment detects a pen tilt forward, this may be translated as equivalent to scrolling upward. If an embodiment detects a pen tilt left or right, this may be translated as equivalent to scrolling left or right, respectively.

To get out of the pen navigation mode, an embodiment may utilize different trigger detection(s) in the case of an active pen at 307. For example, an embodiment may detect that the user simply repeats the same action used to enter the pen navigation mode with the active pen. These particular sets of gestures are thus targeted toward active pen/stylus devices, e.g., with pressure and tilt detection available. However, the first set of gestures, e.g., described in connection with a passive pen, also may be employed using the active stylus. Likewise, it should be understood that various other modes of detection, e.g., of entry into and exit from pen navigation mode, as well as detection of various navigation control inputs (pen navigation inputs), may be implemented over and above the non-limiting examples provided herein, e.g., based on available device components, etc.

Accordingly, the various embodiments provide a defined set of intuitive gestures based on pen inputs to allow easy navigation on/within an application without the drawbacks of conventional solutions, e.g., looking for navigation controls inside a particular application, putting aside and/or misplacement of a pen to free finger/hand for touch gestures, etc.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, via a writing input surface of an information handling device, content input from a pen;
inputting, using a processor, the content input from the pen;
detecting, using a processor, an event triggering entry into a pen navigation mode;
entering, using a processor, the pen navigation mode;
receiving, via the pen, pen navigation inputs; and
controlling, using a processor, navigation based on the pen navigation inputs.

2. The method of claim 1, wherein the detecting an event triggering entry into a pen navigation mode comprises detecting that a pen input to the writing input surface does not change for a predetermined time.

3. The method of claim 1, wherein the detecting an event triggering entry into a pen navigation mode comprises detecting that a pen tilt angle does not exceed a threshold degree of change for a predetermined time.

4. The method of claim 1, wherein the detecting an event triggering entry into a pen navigation mode comprises detecting that a pen pressure is maintained within a threshold range for a predetermined time.

5. The method of claim 1, wherein the controlling navigation based on the pen navigation inputs comprises scrolling content rendered in a display screen according to the pen navigation inputs.

6. The method of claim 5, wherein the scrolling comprises vertical scrolling responsive to detecting vertical movement of the pen.

7. The method of claim 6, wherein the detecting vertical movement of the pen comprises detecting a change in pen tilt angle.

8. The method of claim 6, wherein the detecting vertical movement of the pen comprises detecting a change in pen vertical input movement via the writing surface.

9. The method of claim 5, wherein the scrolling comprises lateral scrolling responsive to detecting lateral movement of the pen.

10. The method of claim 9, wherein detecting lateral movement of the pen comprises detecting a pen movement selected from the group consisting of a change in pen tilt angle and a change in pen lateral input movement via the writing surface.

11. An information handling device, comprising:
a writing input surface;
a processor operatively coupled to the pen input surface;
a memory device that stores instructions accessible to the processor, the instructions being executable by the processor to:
receive, via the writing input surface, content input from a pen;
input the content input from the pen;
detect an event triggering entry into a pen navigation mode;
enter the pen navigation mode;
receive pen navigation inputs; and
control navigation based on the pen navigation inputs.

12. The information handling device of claim 11, wherein to detect an event triggering entry into a pen navigation mode comprises detecting that a pen input to the writing input surface does not change for a predetermined time.

13. The information handling device of claim 11, wherein to detect an event triggering entry into a pen navigation mode comprises detecting that a pen tilt angle does not exceed a threshold degree of change for a predetermined time.

14. The information handling device of claim 11, wherein to detect an event triggering entry into a pen navigation mode comprises detecting that a pen pressure is maintained within a threshold range for a predetermined time.

15. The information handling device of claim 11, wherein to control navigation based on the pen navigation inputs comprises scrolling content rendered in a display screen according to the pen navigation inputs.

16. The information handling device of claim 15, wherein the scrolling comprises vertical scrolling responsive to detecting vertical movement of the pen.

17. The information handling device of claim 16, wherein the detecting vertical movement of the pen comprises detecting a pen movement selected from the group consisting of a change in pen tilt angle and a change in pen vertical input movement via the writing surface.

18. The information handling device of claim 15, wherein the scrolling comprises lateral scrolling responsive to detecting lateral movement of the pen.

19. The method of claim 18, wherein detecting lateral movement of the pen comprises detecting a pen movement selected from the group consisting of a change in pen tilt angle and a change in pen lateral input movement via the writing surface.

20. A product, comprising:
a storage device having code stored therewith, the code being executable by a processor and comprising:
code that receives, via a writing input surface of an information handling device, content input from a pen;
code that inputs the content input from the pen;
code that detects an event triggering entry into a pen navigation mode;
code that enters the pen navigation mode;
code that receives, via the pen, pen navigation inputs; and
code that controls navigation based on the pen navigation inputs.
